(19) United States
(12) Patent Application Publication
(10) Pub. No.: US 2002/0071924 A1
(43) Pub. Date: Jun. 13, 2002

(54) Disposable floor protector

(75) Inventor: Norma Lopez-Valverde, Dallas, TX (US)

Correspondence Address: Michael L. Diaz, Michael L. Diaz, P.C., 555 Republic Drive, Suite 200, Plano, TX, 75074, US

(73) Assignee: Square Box, Inc.

(21) Appl. No.: 09/734,111

(22) Filed: Dec. 11, 2000

(51) Int. Cl. B32B 33/00; B32B 1/02

(52) U.S. Cl. 428/40.1; 428/42.2; 428/43; 428/192; 428/119

(57) ABSTRACT

A disposable floor protector. The disposable floor protector includes a sheet of inexpensive flexible material having a raised border located along the perimeter of the sheet to prevent spilled food and fluids from spreading onto the adjacent uncovered floor. The disposable floor protector also includes a plurality of pressure sensitive, releasable adhesive strips allowing easy removal of the floor protector after use. The disposable floor protector is positioned on the floor to protect the floor it is covering. After use, the floor protector may be discarded.

### BACKGROUND OF THE INVENTION

1. Technical Field of the Invention This invention relates to floor coverings, and more particularly, to a disposable floor protector covering a selected portion of a floor.

2. Description of Related Art

It is well known that feeding a small child can be a very messy ordeal. Typically, the child is placed within a high chair and served food. It is not unusual for more food to be thrown or dropped by the child than is consumed. Obviously the floor underneath the high chair can get very dirty. A parent than must clean under the high chair after each feeding. This cleaning process usually involves moving the high chair and mopping or sweeping the floor. When considering that there are numerous feedings of a child, this process can become tedious, as well as being time consuming.

In past, parents have used various coverings to protect a floor. For example, throw rugs have been placed under a child. Additionally, heavy plastic mats have also been used to protect the floor. However, each of these floor coverings requiring cleaning. The rugs must be vacuumed or cleaned after each use. In addition, the heavy plastic mats must usually be washed off with water. The floor coverings also do not fully protect the floor. For example, when food or fluids are spilled on the floor cover, the spilled fluids and food are not prevented from flowing off the covering onto the adjacent uncovered flooring. These floor coverings also suffer from the tendency of shifting when walked upon. A floor covering is needed which protects the floor and the surrounding uncovered floor, does not require cleaning, does not shift when walked upon, and is easily removed from the floor after use.

Although there are no known prior art teachings of a solution to the aforementioned deficiency and shortcoming such as that disclosed herein, prior art references that discuss subject matter that bears some relation to matters discussed herein are U.S. Pat. No. 4,125,656 to Creamer (Creamer), U.S. Pat. No. 4,483,895 to Deaver (Deaver), U.S. Pat. No. 4,644,592 to Small (Small), and U.S. Pat. No. 4,940,620 to Silk et al. (Silk).

Creamer discloses a disposable, absorbent pad adapted to be formed into a U-shaped configuration and to be placed at least partially about the base of a toilet to absorb moisture gravitating near the toilet's base. The pad is adjustable and includes a water-proof backing as well as means for adhesively bonding the pad to the floor. However, Creamer suffers from the disadvantage of being difficult to remove the pad from the floor after use.

Deaver discloses an absorbent apron for use beneath an infant high chair. The apron includes a liquid impervious sheet and a liquid absorbent non-woven layer of bonded fibrous material. However, Deaver does not teach or suggest a disposable pad having releasable, adhesive strips for affixing the pad to the floor. Deaver suffers from the disadvantage of sliding around when people tread over the apron.

Small discloses a mat for temporary use on a surface subjected to exposure to a highly aqueous environment. The mat includes a water repellant mat member having a surface adapted for frictional engagement with a human body part. A non-hygroscopic, fully releasable, pressure sensitive adhesive film is applied to at least a part of the underside of the mat member. The adhesive film secures the mat to a surface in the water-filled environment and is readily removable without leaving a residue of the adhesive film on the surface. However, Small does not prevent food and other objects from sliding off the mat. When fluids or other substances fall on the Small mat, the fluids can flow out onto the uncovered adjacent flooring.

Silk discloses a mat adapted for placement on a kitchen floor underneath an infant's highchair to intercept food particles or liquids that would otherwise fall onto the floor during the feed of an infant. The mat includes two rectangular panels that are hingedly connected together. Handles on outer edges of the panels enable the mother to carry the mat over to the sink. However, Silk does not teach or suggest a disposable mat having a plurality of adhesive strips for affixing the mat to the floor.

Review of the foregoing references reveals no disclosure or suggestion of an apparatus as that described and claimed herein. Thus, it would be a distinct advantage to have a floor protector for protecting a floor and the adjacent uncovered floor, does not require cleaning, and does not shift when walked upon. It is an object of the present invention to provide such an apparatus.

### SUMMARY OF THE INVENTION

In one aspect, the present invention is a disposable floor protector to protect a selected portion of a floor. The protector includes a sheet of flexible material having a perimeter, a top surface, and a bottom surface. The protector also includes a raised border located along the perimeter of the sheet of material and a plurality of pressure sensitive releasable adhesive strips located on the bottom surface of the sheet. The bottom surface of the sheet is affixed to the floor by the plurality of pressure sensitive adhesive strips.

In another aspect, the present invention is a disposable floor protector to protect a selected portion of floor. The protector includes a sheet of flexible material having a perimeter, a top surface, and a bottom surface. The top surface has a plurality of decorative designs. Additionally, the sheet of material has a plurality of perforations running across a portion of the sheet and a raised border located along the perimeter of the sheet of material. A plurality of pressure sensitive releasable adhesive strips are located on the bottom surface of the sheet. The plurality of adhesive strips have a protective cover strip covering each adhesive strip prior to applying said sheet to the floor. The cover strips are removed to permit the adhesive strips to be releasably affixed to the floor, the bottom surface of the sheet is affixed to the floor by the plurality of pressure sensitive adhesive strips, and the perforations are positioned on the sheet of material to allow the sheet to be removed from the floor with an object such as an object such as a high chair positioned on the top surface of the sheet.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a top plan view of a disposable floor protector in the preferred embodiment of the present invention;

FIG. 2 is a bottom view of the disposable floor protector of FIG. 1;

FIG. 3 is a cross sectional view of the floor protector of FIG. 1 in the preferred embodiment of the present invention; and

FIG. 4 is a top view of a floor protector in an alternate embodiment of the present invention.

### DETAILED DESCRIPTION OF EMBODIMENTS

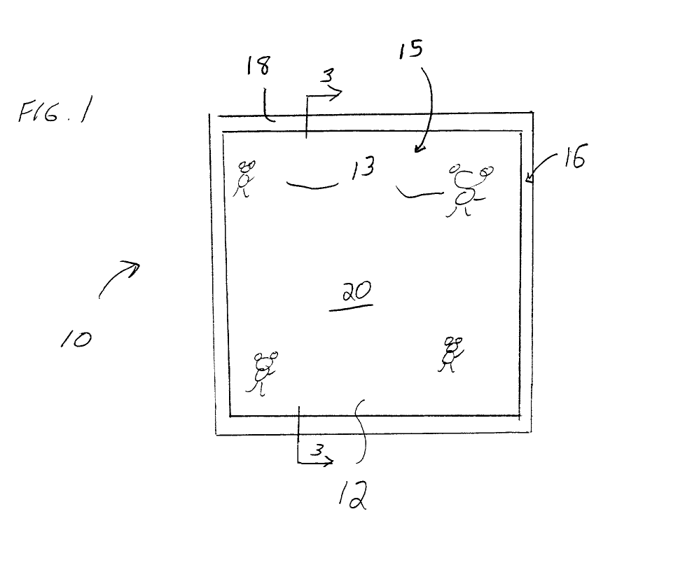

A disposal floor protector is disclosed. FIG. 1 is a top plan view of a disposable floor protector 10 in the preferred embodiment of the present invention. The floor protector includes a sheet 12 constructed out of a light, flexible material, such as paper or plastic (e.g., polyurethane). In the preferred embodiment of the present invention, the material is similar to the material used in conventional kitchen paper towels, being both absorbent and light-weight. In another embodiment of the present invention, the material may be include a plastic coating on a top surface of the sheet. The floor protector is large enough to cover the general vicinity around the child's high chair. The floor protector may also include decorative designs 13 on a top side 15 of the protection. Additionally, the floor protector includes a raised border 16 located around a perimeter 18 of the floor protector. The raised border is a slightly raised portion of the sheet of material. In the preferred embodiment of the present invention, the raised border is a series of folds at the outer edges of the sheet 12, thus achieving a raised surface.

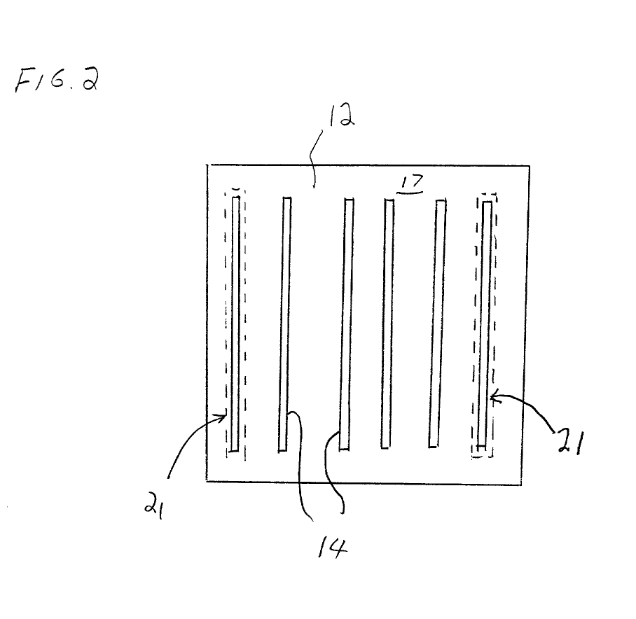

FIG. 2 is a bottom view of the disposable floor protector 10 of FIG. 1. FIG. 2 illustrates a bottom side 17 of the floor protector. The floor protector includes a plurality of adhesive strips 14. The strips provide enough adhesive properties to allow the floor protector to adhere to the floor to which it is covering. Additionally, the strips are fully releasable from the floor when removing the floor protector from the floor, thus allow easy removal of the floor protector from the floor. The removal of the floor protector also does not transfer any residue from the adhesive strips to the floor after removal. Preferably, the adhesive strips are pressure sensitive and fully releasable from the floor. Prior to use, the strips may be covered by removable protective cover strips 21 to prevent inadvertent sticking of the adhesive strips to other objects prior to use on the floor.

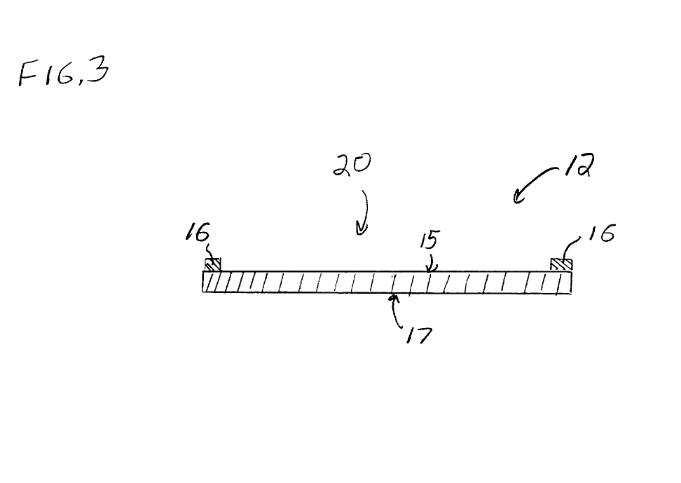

FIG. 3 is a cross sectional view of the floor protector of FIG. 1 in the preferred embodiment of the present invention. The raised border is slightly raised by preferably folding the perimeter of the sheet 12. The raised border prevents any spilled food or fluids from escaping from an interior portion 20 (FIG. 1) of the floor protector.

With reference to FIGS. 1-3, the operation of the floor protector 10 will now be explained. When it is desired to use the floor protector, the plastic cover strips are removed from the adhesive strips 14. The bottom side 15 of the sheet 12 is laid down upon the area of the floor for which the parent wishes to protect. The high chair or dining table is then positioned over the covered floor area. The child is then fed. Any food that is dropped on the floor protector is prevented from going onto the adjacent uncovered floor by the raised border 16. Once feeding time is over, the sheet 12 is removed, with all the dropped food particles contained within the interior portion 20 of the sheet, and discarded. Thus, the floor protector covering the floor requires no cleaning.

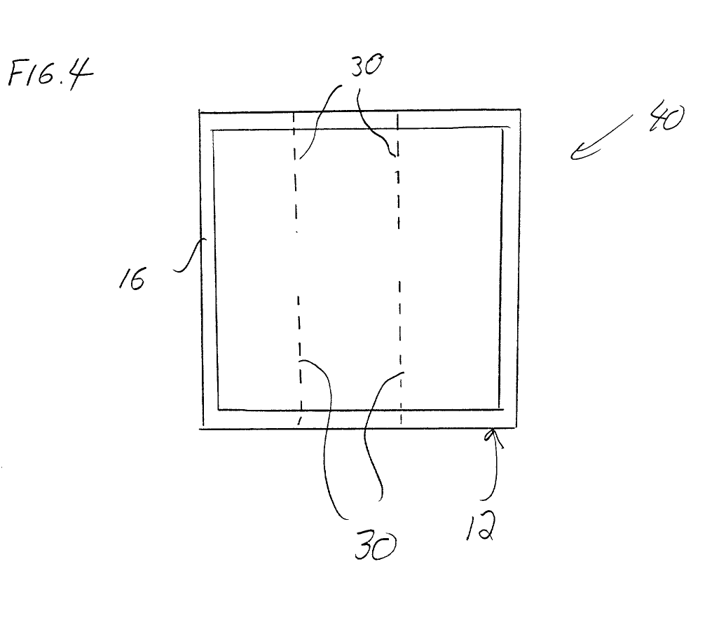

FIG. 4 is a top view of a floor protector 40 in an alternate embodiment of the present invention. The floor protector 40 includes the sheet 12 and the raised border 16. The sheet 12 also includes a plurality of perforated lines 30 running from the perimeter to the interior of the sheet. The perforated lines allow the sheet to be easily torn along the perforated lines. The perforated lines are positioned where a high chair is placed on the floor protector. The underside of the floor protector 40 is identical to the floor protector 10, having the plurality of adhesive strips 14.

The floor protector 40 is utilized in the same manner as the floor protector 10. The floor protector is placed on the floor it is protecting. A high chair can then be positioned on top of the floor protector and a child can then be fed in the high chair. When the feeding process is completed, the floor protector 40 is removed by tearing at the perforated lines. Thus, the floor protector 40 can be removed from the floor without removing the high chair from the floor protector 40.

The floor protector provides many advantages. First, it protects the floor during the feeding of a child. The floor protector includes a raised border to prevent the spread of dropped food and fluids from flowing onto the adjacent uncovered floor. The floor protector is also disposable. Therefore, the floor protector does not need to be cleaned. Additionally, by providing adhesive strips, the floor protector does not slide around.

It is thus believed that the operation and construction of the present invention will be apparent from the foregoing description. While the apparatus shown and described has been characterized as being preferred, it will be readily apparent that various changes and modifications could be made therein without departing from the scope of the invention as defined in the following claims.

What is claimed is:

1. A disposable floor protector to protect a selected portion of a floor, the protector comprising:
a sheet of flexible material having a perimeter, said sheet having a top surface and a bottom surface;
a raised border located along the perimeter of said sheet of material; and
a plurality of pressure sensitive releasable adhesive strips located on the bottom surface of said sheet;
whereby the bottom surface of said sheet is affixed to the floor by said plurality of pressure sensitive adhesive strips.

2. The disposable floor protector of claim 1 wherein said plurality of pressure sensitive releasable adhesive strips include a protective cover strip covering each adhesive strip prior to applying said sheet to the floor, whereby the cover strips are removed to permit the adhesive strips to be releasably affixed to the floor.

3. The disposable floor protector of claim 1 wherein the top surface includes a plurality of decorative designs.

4. The disposable floor protector of claim 1 wherein said sheet of material includes a plurality of perforated lines, whereby the perforated lines are positioned on said sheet of material to allow said sheet to be removed from the floor with an object positioned on the top surface of the sheet.

5. The disposable floor protector of claim 1 wherein said sheet of material is constructed of a water resistant material.

6. The disposable floor protector of claim 5 wherein the water resistant material includes a plastic coating on the top surface of said sheet.

7. The disposable floor protector of claim 1 wherein said sheet is constructed of paper.

8. The disposable floor protector of claim 1 wherein said sheet is constructed of polyurethane.

9. A disposable floor protector to protect a selected floor, the protector comprising:
a sheet of flexible material having a perimeter, the sheet having a top surface and a bottom surface, the top surface having a plurality of decorative designs and the sheet of material having a plurality of perforated lines running across a portion of the sheet;
a raised border located along the perimeter of the sheet of material; and
a plurality of pressure sensitive, releasable adhesive strips located on the bottom surface of the sheet, the plurality of adhesive strips having a protective cover strip covering each adhesive strip prior to applying said sheet to the floor;
whereby the cover strips are removed to permit the adhesive strips to be releasably affixed to the floor, the bottom surface of the sheet being affixed to the floor by the plurality of pressure sensitive adhesive strips, and the perforated lines being positioned on the sheet of material to allow the sheet to be removed from the floor with an object positioned on the top surface of the sheet.
